(19) United States
(12) Patent Application Publication
(10) Pub. No.: US 2012/0009379 A1
(43) Pub. Date: Jan. 12, 2012

(54) Vinyl Acetate-Ethylene-Copolymer Dispersions and Textile Web Material Treated herewith

(75) Inventors: Harmin Müller, Hofheim (DE); Paul Stuart Wormald, Lancashire (GB)

(73) Assignee: CELANESE EMULSIONS GMBH, Kronberg (DE)

(21) Appl. No.: 13/148,545

(22) PCT Filed: Feb. 6, 2010
(86) PCT No.: PCT/EP2010/000745

§ 371 Date: Sep. 28, 2011

(30) Foreign Application Priority Data
Feb. 9, 2009 (DE) 10 2009 008 143.7

(51) Int. Cl. B32B 5/02; D03D 9/00; C09D 131/04

(52) U.S. Cl. 428/96; 524/563; 524/555; 524/547; 442/59; 442/1

(57) ABSTRACT

The invention relates to vinyl acetate-ethylene copolymer dispersions suitable for treating textle web materials, and to textile web material treated therewith, being suitable in particular as floor coverings or as belts. The vinyl acetate-ethylene-copolymer dispersions are characterized by a low ethylene unit content, relatively high glass transition temperatures, and a small particle size.

The present invention deals with vinyl acetate-ethylene dispersions (“VAE dispersions”), that are especially suited for the treatment of textile web material, as well as the textile web material treated therewith, which is especially suited as floor coverings or as belts.

Modern floor coverings can be made from the most diverse material combinations. Thus, they can be made from textiles, such as nonwovens, that are stabilized with a binder; or they can be pile materials, in which threads are worked into a base surface and fixed therein by application of a binder. Furthermore, floor coverings can have several layers that are laminated to each other by binders or adhesives. Besides the actual walking surface in these laminates, a backing layer is placed on the side away from the walking surface. This serves, first, to fix the materials making up the walking surface, and secondly it is critical to the walking comfort.

In the past, binders of the most diverse plastics have been used for the stabilizing of textile surfaces or for the lamination of the most diverse layers (see WO 90/00967 A1). Styrene-butadiene latex is often used. There have already been proposals to use VAE copolymer dispersions for these purposes. Examples of this will be found in GB 1,442,806 A, EP 0 432 391, EP 0 864 685 A1, U.S. Pat. No. 5,084,503 A and U.S. Pat. No. 5,124,394 A.

EP 1 008 689 A2 describes cross-linked carpet backing coatings containing a VAE copolymerizate dispersion derived from 4 to 25 wt. % ethylene, 67 to 95 wt. % vinyl acetate and 0.1 to 8 wt. % of an ethylene-unsaturated hydroxy-functional monomer, as well as a selected cross-linking agent. According to the description, dispersions are used that are stabilized by protective colloid/emulsifier combinations. No details are disclosed as to the properties of the dispersions used, such as ethylene content, glass transition temperature, or particle size of the VAE copolymers.

WO 2006/0071157 A1 describes VAE copolymer dispersions that are suitable for the coating of carpets. The VAE copolymer used is relatively soft and has a glass transition temperature in the range of 0 to −40° C. The ethylene content of these copolymers is correspondingly high.

The VAE copolymers previously proposed for this area of use are generally characterized by a relatively high content of polymerized ethylene units; typically, the content of ethylene units is distinctly above 10 wt. %, in terms of the total quantity of monomers used. Such VAE copolymer dispersions result in a good conglutination strength. But the dimensional stability of the coated products still leaves something to be desired.

VAE copolymer dispersions are also known for other applications. Thus, DE 60 2004 000 117 T2 describes the incorporation of a self-cross linking polymer in a nonwoven binder to improve the wet strength of a moistened wipe cloth. Among the binders described are vinyl ester-ethylene copolymerizates that are derived from 65-85 wt. % of a vinyl ester, 5-30 wt. % of ethylene, and possibly up to 12 wt. % of a cross-linking monomer. The dispersions on account of their ethylene content of more than 5 wt. % are relatively soft. These dispersions would not attain the dimensional stability that is customary for carpets or belts. The dimensional stability of the wipe cloths impregnated with them is not improved, but neither is that required for this application.

DE 10 2006 037 318 A1 discloses a method for the application of a dispersion adhesive by means of nozzles. One preferably uses vinyl ester-ethylene copolymers that are derived from 40-95 wt. % of vinyl esters, up to 45 wt. % ethylene and up to 60 wt. % of other monomers copolymerizable with this. The VAE copolymer dispersions specifically disclosed in this document have ethylene contents of much more than 5 wt. %.

DE 10 2004 023 374 A1 describes preservative-free coating agents containing a selected vinyl ester copolymer and a strongly basic agent to adjust a pH value of the dispersion to a value above 10. Copolymers are described that are derived from vinyl acetate, ethylene and Versatic acids. The ethylene content of these copolymers is typically 15 to 20 wt. %.

DE 691 15 448 T2 describes vinyl acetate-ethylene copolymer emulsions with improved wet adhesion. These can be derived from 70-98 wt. % vinyl acetate and 2-30 wt. % ethylene, and also possibly up to 10 wt. % of other monomers that can copolymerize with this. As the stabilization system, one uses a ternary mixture of polyvinyl alcohols. The mean particle diameters of the resulting dispersions are relatively large and typically lie between 0.8 and 1.2 μm (d_{w}).

DE 600 15 285 T2 describes a method for production of vinyl acetate-ethylene copolymer emulsions stabilized with a polyethylene glycol-polyvinyl alcohol mixture. The copolymers are derived from 50-95 wt. % vinyl acetate and 5-30 wt. % ethylene, and possibly up to 10 wt. % of other monomers that can copolymerize with this. As the stabilization system, one uses a mixture of polyethylene glycol-polyvinyl alcohol. Here as well, the mean particle diameters of the obtained dispersions would be relatively large, typically in the region of much more than 500 nm (d_{w}).

DE 29 49 154 A1 describes a method for production of vinyl acetate-ethylene copolymer dispersions derived from 60-95 wt. % vinyl acetate, 5-40 wt. % ethylene and possibly small amounts of other monomers that can copolymerize with this. The polymerization occurs in presence of a stabilization system of emulsifier and protective colloid. Vinyl acetate and emulsifier are added in batches during the polymerization.

DE 26 01 200 A1 describes an aqueous dispersion of a vinyl acetate-ethylene copolymerizate containing an epoxide component. The epoxide moiety amounts to 0.5 to 60 wt. %, in terms of the total amount of monomers used in the copolymerization. The moiety of vinyl acetate and ethylene is 60-95 wt. % and 5-40 wt. %, respectively, in terms of the total monomer amount. The emulsion polymerization can be carried out in presence of emulsifiers and/or protective colloids.

U.S. Pat. No. 5,180,771 A discloses a dispersion containing a vinyl acetate-ethylene copolymer with 60-94 wt. % vinyl acetate units, 5-30 wt. % ethylene units and 1-10 wt. % cross-linking units, and also containing 1-45 wt. % and tetramethylolglycoluril.

When selecting treatment agents for floor coverings one must pay heed, first, to a sufficiently high bending strength (dimensional stability) of the film or impregnated web material formed from the binder; on the other hand, the film or impregnated web material must not be too brittle, in order to avoid breaking of the textile web material during use.

In the past, when using vinyl acetate homopolymer dispersions (“vac-homopolymer dispersions”) for this purpose, one generally added softening agents to adjust the required property profile. While the VAE copolymer dispersions used thus far conglutinate the fibers well, they are too soft to achieve a satisfactory dimensional stability. Furthermore, softening agents have a tendency to migrate and should therefore be avoided whenever possible.

Selected VAE copolymer dispersions have now been found that are distinguished by good bending strength combined with little brittleness, which make use of very slights amounts or no softening agents and which are excellent for use as binders for textile web material, especially that used as floor covering or as belts. These VAE copolymer dispersions, furthermore, are distinguished by a good dimensional stability and feel.

The problem of the present invention is therefore to provide VAE copolymer dispersions with the aforementioned property profile.

The present invention concerns a vinyl acetate-ethylene copolymer dispersion that is derived from 60 to 99 wt. % vinyl acetate, 1 to 4 wt. %, preferably 1 to 3 wt. %, and most especially preferred 2-3 wt. % ethylene and possibly up to 30 wt. % of other monomers that are copolymerizable with this, wherein the copolymer has a glass transition temperature of +15 to +32° C., a mean particle size d_{w} of 50 to 500 nm, and is stabilized with at least 1 wt. % of emulsifiers and 0-2 wt. % of protective colloids, while in the case of stabilizer systems of emulsifiers and protective colloids the quantity of emulsifier is at least twice that, preferably at least three times that of the quantity of protective colloid.

By vinyl acetate-ethylene copolymer in the context of this specification is meant a vinyl acetate copolymer that is derived at lest from vinyl acetate and ethylene.

The VAE copolymer dispersion according to the invention is primarily stabilized by emulsifiers. This means that either emulsifiers alone are used as the stabilizers or combinations of emulsifiers and protective colloids are used, while in these combinations the emulsifier quantity is to be chosen significantly higher than the quantity of protective colloid.

The viscosity of the vinyl ester-ethylene copolymer dispersions according to the invention is usually 100 to 10,000 mPas, especially 200 to 6000 mPas and most especially preferred 400 to 4000 mPas. For purposes of this specification, the viscosity measurement is done with the Brookfield viscosimeter at 25° C. using spindle 5, at 20 revolutions per minute (rpm).

These viscosity readings pertain to dispersions with a solids content in the range of 40 to 70 wt. %, in terms of the total mass of the dispersion. The viscosity is reduced accordingly in the case of a dilution.

The VAE copolymers of the dispersion according to the invention have glass transition temperatures between +15 and +32° C., preferably from +20 to +30° C. In heterogeneous systems, such as core-shell or hemispheres, the lowest glass transition temperature is between +15 and +32° C., preferably from +20 to +30° C. For purposes of the present specification, the glass transition temperature is determined by DSC measurement with a heating rate of 10 K/minute.

The copolymers of the dispersion according to the invention are furthermore characterized by very small mean particle diameters. These are indicated in the form of dw values and lie between 50 and 500 nm, preferably between 100 and 300 nm. Determination of the particle size distribution is done for purposes of the present invention by means of laser aerosol spectroscopy. The distribution width plays a lesser role in the application according to the invention. Typical distribution widths dw/dₙ are in the range of 1.02 to 6.

Surprisingly, it has been found that the vinyl acetate-ethylene copolymer dispersions according to the invention are especially well suited as binders and as adhesives for textile web materials and provide a very good balance between dimensional stability and flexibility. It has been found that vinyl acetate-ethylene copolymers with a relatively small fraction of ethylene units and a high fraction of very fine polymer particles can be readily used for this application. Thanks to the deliberate incorporation of a certain fraction of “soft” monomer ethylene, possibly in combination with additional comonomers, such as acrylates, one can control the processing and usage properties of the VAE copolymerizates of the invention.

The VAE copolymer dispersions according to the invention are made by radical emulsion polymerization of at least vinyl acetate and at least ethylene and are stabilized principally by emulsifiers. The monomer combination is chosen such that the copolymers of the VAE copolymer dispersions according to the invention have glass transition temperatures in the above indicated range. Heterogeneous systems, such as core-shell or hemispheres, can have several glass transition temperatures; in this case, at least one glass transition temperature is found in the aforementioned range, while the glass transition temperature of the other phase can also be above this range.

Besides vinyl acetate and ethylene, the VAE copolymer according to the invention can be derived from other monomers that can be copolymerized with them and having at least one monoethylene-unsaturated group. As the monomers having at least one monoethylene-unsaturated group one will consider familiar radical polymerization monomers. In any case, these are to be chosen such that vinyl ester-ethylene copolymers are formed with the above indicated glass transition temperatures.

One can produce polymers with homogeneous and heterogeneous morphologies.

Furthermore, monomers that can copolymerize with vinyl acetate and ethylene and have at least one monoethylene-unsaturated group can be divided into those having at least one functional group that gives the VAE copolymer a particular reactive property (“functional monomers”) and those having no such functional group (“nonfunctional monomers”). These nonfunctional monomers can be used, e.g., to adjust the glass transition temperature or the hydrophobic or hydrophilic properties of the VAE copolymers.

The fraction of the functional monomers in the VAE copolymer can be between 0 and 10 wt. %, preferably between 0 and 5 wt. %.

The fraction of the nonfunctional monomers in the VAE copolymer can be between 0 and 20 wt. %, preferably between 0 and 10 wt. %, the total amount of functional and nonfunctional monomers being not more than 30 wt. %.

Examples of functional monomers are ethylene-unsaturated acids, such as mono- or dicarboxylic acids, sulfonic acids or phosphonic acids. Instead of the free acids, their salts can also be used, preferably alkaline or ammonium salts.

Examples of these are acrylic acid, methacrylic acid, crotonic acid, maleic acid, fumaric acid, itaconic acid, vinylsulfonic acid, vinylphosphonic acid, styrene sulfonic acid, semi-esters of maleic or fumaric acid and of itaconic acid with monovalent aliphatic saturated alcohols of chain length C₁-C₁₈ and their alkaline and ammonium salts or (meth)acrylic acid esters of sulfoalkanols, such as sodium-2-sulfoethylmethacrylate.

Further examples of functional monomers are ethylene-unsaturated monomers that have at least one amide, epoxy, hydroxy, N-methylol, trialkoxysilane or carbonyl group.

Especially advantageous here are ethylene-unsaturated epoxide compounds, like glycidylmethacrylate or glycidylacrylate; ethylene-unsaturated N-methylol compounds like N-methylolacrylate or -methacrylate; or methacrylic acid and acrylic acid C₁-C₉-hydroxyalkyl esters, like n-hydroxyethyl-, n-hydroxypropyl- or n-hydroxybutylacrylate and methacrylate; as well as compounds like diacetone acrylamide and acetylacetoxyethylacrylate or -methacrylate; or amides of ethylene-unsaturated carboxylic acids, like acrylamide or methacrylamide. Especially preferred is a combination of acrylamide and N-methylolacrylamide. These VAE copolymers are distinguished by an especially low tendency to formaldehyde cleavage.

Examples of nonfunctional monomers are vinyl esters that are not vinyl acetate. Examples of this are vinyl esters of monocarboxylic acids having one to eighteen carbon atoms, like vinyl formiate, vinyl propionate, vinyl butyrate, vinyl isobutyrate, vinyl benzoate, vinyl-2-ethyl hexanoate, vinyl esters of a-branched carboxylic acids with 5 to 11 carbon atoms in the acid residue (®Versatic acids), vinyl esters of pivalic, 2-ethylhexanoic, lauric, palmitic, myristic and stearic acid. Vinyl esters of Versatic acids, especially VeoVa® 9, VeoVa® 10 and VeoVa® 11, are preferred.

Further examples of nonfunctional monomers are alpha-olefins that are not ethylene, or vinyl aromatics. Examples of these are propylene, 1-butylene, 2- butylene, styrene or α-methylstyrene.

Further examples of nonfunctional monomers are esters of ethylene-unsaturated monocarboxylic acids or diesters of ethylene-unsaturated dicarboxylic acids. Preferably, this involves esters of alcohols with one to eighteen carbon atoms. Examples of such nonfunctional monomers are methylmethacrylate or -acrylate, butyl-methacrylate or -acrylate, 2-ethylhexyl methacrylate or -acrylate, dibutylmaleinate or dioctylmaleinate.

An especially preferred vinyl acetate-ethylene copolymer dispersion is derived from a vinyl acetate-ethylene copolymer that was obtained by emulsion polymerization of vinyl acetate and ethylene and possibly at least one additional monomer that can polymerize with this in presence of at least one nonionic emulsifier and/or at least one anionic emulsifier, wherein possibly up to 2 wt. %, in terms of the total main monomer (=vinyl acetate, ethylene and nonfunctional monomer possibly used) of a molecular or dispersed water-soluble polymer can be present.

Emulsifiers used with preference are nonionic emulsifiers with alkylene oxide groups and/or anionic emulsifiers with sulfate, sulfonate, phosphate and/or phosphonate groups, which can be used together with molecular or dispersed water-soluble polymers, preferably together with polyvinyl alcohol.

Another preferred variant of the VAE dispersions according to the invention contains vinyl acetate-ethylene copolymers that additionally contain 0.5 to 20 parts by weight of esters of acrylic acid and/or esters of methacrylic acid and/or diesters of maleic acid with monovalent saturated alcohols, especially butylacrylate (BuA) and/or 2 ethylhexylacrylate (2-EHA) and/or dibutylmaleinate and/or dioctylmaleinate polymerized in them.

The solid fraction of the VAE copolymer dispersions according to the invention typically amounts to 40 to 70 wt. %, preferably 45 to 60 wt. %, in terms of the total mass of the dispersion, especially preferably between 48 and 55%. These dispersions can be diluted for use, in which case the viscosity changes accordingly.

The VAE copolymer dispersion according to the invention contains emulsifiers, especially nonionic emulsifiers E1 and/or anionic emulsifiers E2. If combinations of nonionic emulsifiers with anionic emulsifiers are used, the ratio of E1:E2 is usually 1:1 to 50:1. The VAE copolymer dispersion can additionally contain small amounts of polymer stabilizers (protective colloids).

Examples of nonionic emulsifiers E1 are acyl, alkyl, oleyl and alkylaryl oxethylates. These products are available commercially by the name Genapol®, Lutensol® or Emulan®. They include, for example, ethoxylated mono-, di- and tri-alkylphenols (EO degree: 3 to 50, alkyl-substituent residue: C₄ to C₁₂) and ethoxylated fatty alcohols (EO degree: 3 to 80; alkyl residue: C₈ to C₃₆), especially C₁₂C₁₄ fatty alcohol (3-40) ethoxylates, C₁₃C₁₅ oxoalcohol (3-40) ethoxylates, C₁₆C₁₈ fatty alcohol (11-80) ethoxylates, C₁₀ oxoalcohol (3-40) ethoxylates, C₁₃ oxoalcohol (3-40) ethoxylates, polyoxyethylene sorbitan monooleate with 20 ethylene oxide groups, copolymers of ethylene oxide and propylene oxide with a minimum content of 10 wt. % ethylene oxide, the polyethylene oxide (4-40) ether of oleyl alcohol and the polyethene oxide (4-40) ether of nonylphenol. Especially suitable are the polyethylene oxide (4-40) ether of fatty alcohols, especially of oleyl alcohol, stearyl alcohol or C₁₁ alkyl alcohols.

Of nonionic emulsifiers E1, one typically uses 1 to 8 wt. %, preferably 1 to 5 wt. %, especially preferably 1 to 4 wt. %, in terms of the total main monomer quantity. One can also use mixtures of nonionic emulsifiers.

Examples of anionic emulsifiers E2 are sodium, potassium and ammonium salts of straight-chain aliphatic carboxylic acids of chain length C12-C20, sodium hydroxyoctadecane sulfonate, sodium, potassium and ammonium salts of hydroxy-fatty acids of chain length C12-C20 and their sulfonation or sulfating and/or acetylation products, alkylsulfates, also as triethanolamine salts, alkyl-(C10-C20) sulfonates, alkyl(C10-C20)-arylsulfonates, dimethyldialkyl(C8-C18)-ammonium chloride, and their sulfonation products, lignin sulfonic acid and its calcium, magnesium, sodium and ammonium salts, resin acids, hydrogenated and dehydrogenated resin acids and their alkaline salts, dodecylated diphenylether disulfonic acid sodium, sodium lauryl sulfate, sulfated alkyl or arylethoxylates with an ethoxylation degree between 1 and 10, such as ethoxylated sodium lauryl ether sulfate (EO degree of 3) or a salt of a bis-ester, preferably a bis-C₄-C₁₈-alkyl ester, a sulfonated dicarboxylic acid with 4 to 8 carbon atoms or a mixture of these salts, preferably sulfonated salts of esters of succinic acid, especially preferably salts like alkaline metal salts of bis-C₄-C₁₈-alkyl esters of sulfonated succinic acid, or phosphates of polyethoxylated alkanols or alkylphenols.

Especially preferred, one uses emulsifiers that do not contain any alkylphenylethoxylates.

Of anionic emulsifiers E2, one typically uses 0.1 to 3 wt. %, preferably 0.1 to 2 wt.%, especially preferably 0.5 to 1.5 wt. %, in terms of the total main monomer amount. One can also use mixtures of anionic emulsifiers.

One can also use mixtures of nonionic and anionic emulsifiers. The weight fraction of emulsifiers E1 to E2 can vary in broad limits, for example, between 50:1 and 1:1.

In addition to the emulsifiers used during the emulsion polymerization and possibly protective colloids, the VAE copolymer dispersions according to the invention can also contain subsequently added water-soluble or water-dispersible polymers and/or subsequently added emulsifiers.

Typically, the total fraction of emulsifiers, in terms of the total monomer quantity, is 1 to 8 wt. %, preferably 1 to 6 wt. %, especially preferred 1 to 4 wt. %.

Besides emulsifiers, the vinyl ester-ethylene copolymer dispersions according to the invention can contain protective colloids, preferably polyvinyl alcohols and/or their modifications. Protective colloids—if present—are generally only in relatively low concentrations, such as for example up to 2 wt. %, in terms of the total amount of main monomers used. Preferably, the vinyl ester polymer dispersions used according to the invention contain no protective colloids or up to 1 wt. %, in terms of the total amount of main monomers used.

The protective colloids are water-soluble or water-dispersible polymers that are present during the emulsion polymerization and stabilize the resulting dispersion. Emulsifiers are low-molecular compounds that stabilize the emulsion as well as the formed product.

Examples of protective colloids are water-soluble or water-dispersible polymeric modified natural substances, such as cellulose ether, e.g. methyl, ethyl, hydroxyethyl or carboxymethyl cellulose; water-soluble or water-dispersible polymeric synthetic substances, such as polyvinylpyrrolidone or polyvinylalcohols or their copolymers (with or without residual acetyl content), partially esterified or acetalized polyvinyl alcohol, or etherified with saturated residues.

The protective colloids can be used singly or in combination. In event of combinations, they differ in their molecular weights or they differ in their molecular weights and their chemical composition, such as the degree of hydrolysis.

Preferably, one uses polyvinyl alcohols; these can be hydrophobically or hydrophilically modified in any desired way.

The VAE copolymer dispersions according to the invention can possibly contain still other customary additives for the formulation of binders and adhesives.

This include, for example, film forming adjuvants, such as test benzine, Texanol®, TxiB®, butyl glycol, butyl diglycol, butyldipropylene glycol and butyltripropylene glycol; wetting agents, such as AMP 90®, TegoWet.280®, Fluowet PE®; thickeners like polyacrylate or polyurethane, such as Borchigel L75® and Tafigel PUR 60®; defoaming agents, such as mineral oil or silicone defoaming agents; UV-protecting agents, such as Tinuvin 1130®; agents for adjusting the pH value; preservatives; subsequently added stabilizing polymers, such as polyvinylalcohol or cellulose ether, fillers, like chalk or calcium carbonate; pigments like carbon black; and other additives and adjuvants as are used customarily in the formulation of binders or adhesives.

The fraction of these additives in the VAE-dispersions according to the invention can vary in wide ranges and will be chosen by the skilled person in regard to the desired field of application.

When used as coating agent for floor coverings, other latexes known in this field, such as SBR-dispersions, can be combined with the dispersion according to the invention. The fraction of these additional dispersions can amount to as much as 30 wt. %.

Moreover, it should be pointed out that the dispersion according to the invention can be formulated with a high content of filler or pigment. Thus, typically as much as 80 wt. % of these solids can be incorporated in the dispersion.

Softeners are generally not contained in the VAE copolymer dispersions according to the invention, although the presence of small fractions of these is not precluded.

Preferred VAE copolymer dispersions according to the invention are distinguished by very low content of VOC, especially VOC content of less than 1000 ppm, especially preferably less than 500 ppm, in terms of the total mass of the dispersion. By VOC is meant in the context of this specification organic substances having a boiling point less than 250° C. and not having any acid function.

The VAE copolymer dispersions according to the invention are produced by radical emulsion polymerization of the monomers in presence of at least one emulsifier. Examples of this are given above.

The production of aqueous polymer dispersions has been often described and is therefore familiar to the skilled person [see, e.g., Encyclopedia of Polymer Science and Engineering, Vol. 8, p. 659 et seq. (1987)].

The emulsion polymerization can be carried out, for example, as a batch process with the entire amount of monomers being presented at the start of the polymerization; alternatively, a feed process can be used, in which the adding of the monomers is done during the polymerization by continual feeding; but also a portion of the monomers, such as up to 50 wt. %, preferably up to 25 wt. %, can be present at the start and the rest added during the polymerization.

The process carried out with continuous feeding and up to 25% of monomers in the receiver is especially simple and can be carried out in short polymerization time, for example, in times of 1 to 4 hours.

The polymerization can also be carried out in known manner in several stages with different monomer combinations or in different pressure stages, wherein polymer dispersions with particles of heterogeneous morphology are formed.

The polymerization of the ethylene-unsaturated monomers is done in presence of at least one initiator for the radical polymerization of the ethylene-unsaturated monomers.

As initiators for the radical polymerization at the start and the further polymerization during the production of the dispersions, one will consider all known initiators that are capable of starting a radical, aqueous polymerization in heterophase systems.

These may be peroxides, such as alkaline metal and/or ammonium peroxodisulfates or azo-compounds, especially water-soluble azo-compounds.

As polymerization initiators, one can also use so-called redox initiators. Examples of these are tert.-butylhydroperoxide and/or hydrogen peroxide in combination with reducing agents like sulfur compounds, e.g., the sodium salt of hydroxymethane sulfinic acid, Brüggolit FF6 and FF7, Rongalit C, sodium sulfite, sodium disulfite, sodium thiosulfate and acetone bisulfate adduct, or with ascorbic acid or with reducing sugars.

The amount of initiators or combinations of initiators used in the process varies in the usual range for aqueous polymerization in heterophase systems. As a rule, the amount of initiator used will not exceed 5 wt. %, in terms of the total amount of monomers being polymerized.

Preferably the amount of initiators used, in terms of the total amount of monomers being polymerized, is 0.05 to 2.0 wt. %.

The total amount of initiator can already be present in the receiver at the start of the polymerization or preferably a portion of the initiator is present at the start and the rest is added continuously after the start of the polymerization in one or more steps. The feeding can be done separately or along with other components, such as emulsifiers or monomer emulsions.

It is also possible to start the emulsion polymerization by using a seed latex, such as 0.5 to 15 wt. % of a dispersion in the receiver.

The molecular weight of the polymerizates of the aqueous VAE-dispersions can be adjusted by adding slight amounts of one or more substances regulating the molecular weight. These so-called regulators are generally used in a quantity of up to 2 wt. %, in terms of the monomers being polymerized. As regulators, one can use all substances known to the skilled person. Preferable are, e.g., organic thio-compounds, silanes, allylalcohols and aldehydes.

The polymerization temperature is generally 20 to 150° C. and preferably 50 to 120° C.

The polymerization usually takes place under pressure, preferably between 2 and 150 bar, especially preferably 2 to 35 bar.

After the actual polymerization reaction, it may be desirable and/or necessary to make the resulting aqueous vinyl ester polymer dispersion largely free of odor-causing substances, such as residual monomers and other volatile organic components. This can be accomplished in familiar fashion, such as physical or distillative removal (especially by steam distillation) or by stripping with an inert gas. Moreover, the lowering of the residual monomers can also be done chemically by radical post-polymerization, especially by the action of redox-initiator systems, such as are described in DE-A-4,435,423, for example. Preferred is a post polymerization with a redox-initiator system of at least one organic peroxide and one organic and/or inorganic sulfite and/or sulfinic acid derivates.

Especially preferred is a combination of physical and chemical methods, wherein after a lowering of the residual monomer content by chemical post polymerization the further lowering of the residual monomer content is done by physical methods to preferably <2000 ppm, especially preferably <1000 ppm, in particular <100 ppm.

The polymerization is usually done at a pH value in the range of less than or equal to 9. To adjust the pH value of the VAE-copolymer dispersion, one can in theory use buffer systems, such as sodium acetate or phosphate buffer systems.

Preferable is a pH range of 2 to 9, and a pH value in the range of 3 to 8 is preferred.

The VAE copolymer dispersion according to the invention can be used preferably as binders for textile web materials, especially as binders for carpets, carpet tiles or belts, or for the conglutination of the most diverse layers of textile web materials, especially of carpets, carpet tiles or belts.

It has been found that the dispersions used according to the invention have a good compatibility with pigments and fillers.

The invention furthermore concerns a textile web material that is treated with the above-described VAE copolymer dispersion.

By treatment in the sense of the present specification is meant an impregnating and/or a coating of the textile web material. The VAE copolymer dispersion can in one extreme case penetrate entirely into the textile web material and thoroughly impregnate it, while the binder enters into physical and/or chemical interactions with the textile fibers. In another extreme case, the VAE copolymer dispersion forms a separate layer on one surface of the textile web material, but also partly penetrates into the textile web material and forms physical and/or chemical interactions with the textile fibers. All transitional forms between these two extreme cases are possible.

The treatment can occur during the production of the textile web material, for example, in order to stabilize a nonbonded nonwoven, and/or a coating and a partial impregnation can occur afterwards on at least one side of the textile web material. If the textile web material is to be used as floor covering, such as carpet or carpet tile, or as a belt, this coating and partial impregnation is done on the side that is away from the walking side or the side facing the user; furthermore, in this application, preferably at least one secondary backing layer is provided.

The invention therefore preferably concerns a textile composite comprising a textile web material that is coated and partly impregnated with the above-described vinyl ester-ethylene copolymer dispersion and joined to at least one additional backing layer on the side coated therewith.

The VAE-dispersions can be used advantageously in the manufacture of woven carpets or tufted carpets. In this technique, the emulsion in undiluted or in diluted form is applied to the back side of a woven or tufted web material. After drying, the polymer confers on the carpet an excellent tuft formation, dimensional stability, and improved laying properties.

The invention therefore concerns preferably a textile web material in the form of a woven carpet or a tufted carpet, that is coated and partly impregnated on the side away from the walking side with the above-described VAE-dispersion.

In this variant, one preferably uses textile web materials with a weight per unit of area of 1000 to 3000 g/m², especially 1200 to 2500 g/m².

The VAE-dispersions can also be used for the conglutination of a secondary backing layer of carpets. For this, the emulsion is applied to the secondary back coating and then combined with the textile web, which forms the walking surface.

The invention furthermore preferably concerns a textile web material in the form of a carpet in which a textile web is conglutinated with a secondary back coating on the side away from the walking surface, the conglutination being done between two layers by the above-described VAE-dispersion.

A further application of the VAE-dispersions concerns their use in the manufacture of carpets from heavy nonwovens for temporary use. In this application, a nonwoven is fully impregnated with the VAE-dispersion. After drying, one obtains a product with very good lifetime, dimensional stability, and feel.

The invention furthermore preferably concerns a textile web material in the form of a carpet in which a textile web based on a heavy nonwoven is impregnated with the above-described VAE-dispersion. In this variant, one preferably uses nonwovens with a weight per unit of area of 200 to 600 g/m², especially 250 to 500 g/m².

Yet another application of the VAE-dispersions concerns their use in the making of belts, especially those used for transport safety. The VAE-dispersion confers on the belts a sufficient rigidity and serves for the fixation of pigments. These belts are used in the transportation industry, e.g., to secure loads on trucks during the transport.

The invention furthermore preferably concerns a textile web material in the form of a belt, in which a textile web is impregnated with the above-described VAE-dispersion, preferably with a VAE-dispersion containing fillers and/or pigments.

In this variant, one preferably uses textile web materials with a weight per unit of area of 500 to 3000 g/m², especially 1000 to 2000 g/m².

As the textile web material, one can use the most diverse types. Examples are nonwovens, wovens, scrims or knitted goods. Advantageously, one can also use pile materials; these are coated and partly impregnated on the side away from the pile with the VAE copolymer dispersion according to the invention; they can have open and/or closed loops.

One type of modern floor covering is made from a base fabric and a pile joined to it. The pile is joined to the base fabric and covers it on the walking side. On the side away from the pile, these textile web materials are provided with a backing layer. This serves, on the one hand, for the fixing of the pile in the base fabric and, on the other hand, it is critical to the walking comfort. Textile floor coverings of the above-described type are generally known in commerce as “carpeting” and such carpeting is sold and laid either as roll goods or in the form of carpet tiles. Textile floor coverings can be woven, tufted, or made by the needle-felting technique. In the case of woven and tufted carpets, one distinguishes structures with closed loops, such as “boucle” carpets, and those with cut-open pile nops, such as velour carpets. In the case of tufted carpets, the textile fiber, generally polyamide, is inserted after the tufting process into the finished base fabric by the sewing machine principle. The base fabric here ensures a dimensional stability and the pile ensures the appearance and some of the walking comfort.

The aforementioned textile composites are furthermore provided in familiar fashion with layers of flexible plastic on the back side. One of these layers, called the primary backing layer, serves principally for the fixing of the textile fibers introduced into the base fabric or the fixing of the textile web material. For this purpose, in the past binders based on VAE copolymer dispersions had already been used. An additional plastic layer, called the secondary backing layer, made for example of natural rubber, from styrene-butadiene latexes, from polyvinyl chloride or from polyurethanes, is generally between 2 and 8 mm thick and contributes greatly to the walking comfort thanks to its elastomeric property. The aforesaid secondary backing layer is generally a foam material and provides the so-called foam backing. Besides the already mentioned walking comfort, the foam backing also ensures temperature and sound isolation and also generally has a relatively long lifetime. The secondary backing layer is generally joined to the textile web material by lamination. For this, a direct joining to the primary backing layer can be done, for example, or a glue layer can be placed between primary and secondary backing layer.

As the secondary backing layer, one can employ customary materials. Examples of these are foam or compact foam backing or nonwovens, which can be joined or meshed with other textile web materials, such as wovens or knitteds, thereby strengthening the backing layer in the lengthwise, or in the lengthwise and transverse direction. The secondary backing layer can be treated for electrostatic leakage if necessary, and it can be given an appropriate textile look and feel.

To achieve an adequate walking comfort depending on the laying situation, secondary backing layers are generally used with a weight per unit of area of 100 to 900 g/m² and a thickness of 0.5 to 10 mm.

The textile web of the invention can be modified in the usual way and adapted to the desired use. Thus, carpets are generally treated for antistatic, by having conductive fibers mixed in with them, which bring about a lowering of the surface resistance.

The textile web according to the invention can basically be manufactured in various ways. The manufacturing ways of textile webs are familiar to the skilled person.

In general, all types of fibers and fiber blends can be used. For example, if one starts with the typical manufacture of spun fiber nonwovens, this is made into a commercial product by the process stages of “opening—mixing—fine opening—web formation—bonding”.

Furthermore, both a nonbonded and a bonded web material can be used to make the textile web according to the invention. A nonbonded web can be consolidated by means of a stitch-bonding technique, such as the so-called Maliwatt method. It is also possible to work with an already consolidated web, which has been consolidated by mechanical, chemical or thermal process steps, for example.

Suitable as nonwovens, besides the staple fiber webs, are also so-called filament webs, which are subdivided into nonwovens formed by distributed filaments (endless fibers), so-called spunbonds, or nonwovens formed by distributed fibers by the melt-blown principle. Here as well, the bonding of the nonwovens can be done by the methods already described.

An especially economical variant of a nonwoven is textile webs made from ribbon material. Ribbon material, which is familiar in the textile industry and used in many cases, is generally made by the flat foil extrusion process, wherein the extruded flat foil is cut into ribbons of appropriate width. The raw material used is polyolefins, polyamides and polyesters, i.e., the same materials from which the nonwoven can also be made.

The nonwoven can also be joined to another textile web material, such as a woven or knitted material made from filament yarn or fiber yarn. By filament yarn is meant a yarn that consists of several endless threads with or without twisting, wherein the endless threads can also have a texturized shape. In the latter case, the otherwise smooth filament yarn is given a textile appearance in a texturizing process by providing a high bulk to the filament yarn. Here as well, one can use both polyolefins and polyamides or polyesters as the raw material.

By fiber yarns, especially staple fiber yarns, is meant those which are made from fibers of appropriate length, generally manufactured by the ring spinning or rotor spinning process. Here as well, polyolefins like polypropylene or polyethylene, polyamides and polyesters are suitable as the raw material.

The invention also concerns the use of the above-described VAE-copolymer dispersion for the treatment of textile web materials, especially those which are used in the manufacture of floor coverings or belts. In these applications, an excellent dimensional stability is required.

The following examples explain the invention without limiting it.

Measurement Methods

Measurement of the Particle Size Distribution

The particle size was determined by means of laser-aerosol spectroscopy. This is described in the publication “Kunstharz Nachrichten 28, Characterization and quality assurance of polymer dispersions, October 1992, Dr. J. Paul Fischer”. The method uses as its light source a Nd:YVO4 laser (Millenia II) from Spectra Physics with a laser intensity of 2 W and a wavelength of 532 nm. The detector is a Bialkali Photokathode Type 4517 from Burle (formerly RCA). The scattered light of the previously spray-dried particles was detected in an angle of 40°. The signal evaluation takes place with a multichannel analyzer from TMCA with 1024 channels.

For the preparation of the sample, 0.2 ml of the studied sample was diluted in 100 ml of highly pure water with a conductivity of 18.2 pS/m. The sample was sprayed through a Beckmann nozzle and dried with nitrogen. The resulting particles were neutralized with beta radiation (Kr-85) and then studied by the single particle light scattering experiment. As the result, the counts and mass fractions of the distribution were calculated in the range of 80 nm to 550 nm and put out as mean values dₙ, d_{w}, d_{z} and d_{w}/dₙ.

Glass Transition Temperature

The measurement of the glass transition temperature was done with a Mettler DSC 820 at 10 K/min. The second heating curve was evaluated.

Tensile Strength, Dry and Wet

The samples were prepared by saturation of Whatman paper No. 1 to dosage of 20 wt. % of emulsion. The samples were conditioned for 24 hours prior to the experiment at 23° C. and 50% relative humidity.

Whatman paper is usually employed in comparison experiments for polymer film applications in carpets, as it represents a very uniform substrate. It can be assumed that the results obtained are an indicator of the performance in carpet applications.

The tensile strength testing was done on a Lloyd LR100K instrument, using a 100 KN loading cell. The following test settings were used: pulling speed: 100 mm per minute; 50 mm wide specimen; spacing of the clamping jaws: 200 mm. The sample was stretched to breaking and the force was recorded in N per 50 mm. The results were presented as mean values of four measurements with the same substrate.

For determining the tensile strength on a wet specimen, the test was carried out as above with the change that the specimen prior to the experiment was dipped into deionized water for one hour.

Water Drop Test

The samples were made by saturation of Whatman paper No.1 to a dosage of 20 wt. % of emulsion. Prior to the experiment, the samples were conditioned for 24 hours at 23° C. and 50% relative humidity.

A water drop of 0.3 ml was placed by a burette on the specimen and a stop watch was started. As soon as the water drop disappeared, established by visual inspection, the time indicated by the stop watch was noted down and this was used as the result. Hydrophilic binders typically show results in the range of 1 to 15 minutes; hydrophobic binders show results of more than 1 hour.

Yellowing Test

The samples were made by saturation of Whatman paper No.1 to a dosage of 20 wt. % of emulsion. Prior to the experiment, the samples were conditioned for 24 hours at 23° C. and 50% relative humidity.

The specimen was exposed in a Mathis Lab Dryer for the desired length of time (e.g., 1 min) to the desired temperature (180° C. or 200° C.) and the degree of yellowing was determined with a Minolta CM3600d spectrophotometer. The results were indicated in the form of the yellowing index per DIN 6167. The higher the number, the stronger the yellowing of the specimen.

Stiffness (Dimensional Stability)

The stiffness of the specimen was compared by means of the following described method with a Standard SBR Latex having a backing coat. The binder dispersion was diluted to 25% solid content and applied to a woven carpet (Axminster type based on polyester/polyamide; weight per unit of area, untreated: 1600 g/m²). The amount applied each time was 100 g/m² solid substance. The specimens of 20 cm×20 cm×1 cm were dried for 8 minutes in a Mathis Lab Dryer at 110° C. and the stiffness and bending strength were manually determined. A scale of 1 to 6 was used, assigning a 6 to very stiff specimens and a 1 to very elastic specimens.

Fracture Behavior at 180°

The binder dispersion was diluted to 25% solid content and applied to a woven carpet (Axminster type based on polyester/polyamide; weight per unit of area, untreated: 1600 g/m²). The amount applied each time was 100 g/m² solid substance. The specimens of 20 cm×20 cm×1 cm were dried for 8 minutes in a Mathis Lab Dryer at 110° C. and the breaking behavior was determined manually by hearing. The breaking behavior was characterized as “yes” or “no”.

Pile Nop Pull-Out Force for Textile Floor Coverings (Tuft Anchorage Test)

The textile floor covering samples being tested consist of a blend of goat hair and sheep wool in a ratio of 50 wt. % to 50 wt. %. The binder (dispersion) is diluted with water to a solid of 25% and applied manually with a sponge, well distributed, to the back of the textile floor covering specimen. A quantity of 200 g dry polymer per square meter of carpet is applied. After this, the sample is dried for 30 min at 130° C. and then kept for 24 h at 23° C. / 50% rel. humidity. The pile nop pull-out force is determined according to ISO 4919 at 23° C./50% rel. humidity by measuring the force/weight in a tensile stretching machine at which a loop is detached from the textile flooring. The result is measured and indicated in kg. The test is repeated a total of five times and the average is formed. The measurement error is around 20%.

### EXAMPLES

### Example 1

### Preparation of a Polymer Dispersion According to the Invention—4 wt. % Ethylene

This example describes the preparation of a dispersion with 4 wt. % of ethylene, in terms of the quantity of principal monomer (=ethylene+vinyl acetate).

In a pressure apparatus with anchor agitator (150 rpm), heating jacket and dispensing pumps and a volume of 26.3 I, an aqueous solution was prepared, consisting of the following ingredients:

9495 g deionized water

534 g Celvol® 523 solution (15% in deionized water, polyvinylalcohol from Celanese)

32 g sodium acetate (anhydrous)

213 g sodium ethene sulfonate (30%)

533 g Emulsogen® EPN 287 (70% in deionized water, nonionic emulsifier based on ethoxylate from Clariant)

416 g Texapon® K 12/15 (15% in deionized water, sodium dodecylsulfate from Cognis)

5.0 g sodium disulfite

0.03 g Mohr's salt

The polyvinylalcohol was previously dissolved in a 15% solution at 90° C. for 2 hours. The apparatus was cleared of oxygen in the air. 5% of the vinyl acetate quantity (total quantity: 12269 g) was added to the reactor. The ethylene valve was opened and 6.8% of ethylene (total quantity 314 g) was forced up at around 10 bar. At the same time, the temperature was raised to 65° C. At 55° C. the initiator 1 (28 g of sodium peroxodisulfate in 223 g of deionized water) was quickly added. When 65° C. was reached, the rest of the vinyl acetate was added in 210 minutes and the ethylene valve was opened until the entire quantity of ethylene was in the reactor. The pressure remains at a maximum of around 15 bar. After 180 minutes, an initiator solution 2 (13 g sodium peroxodisulfate in 223 g of deionized water) was added to the vinyl acetate dosage.

After the vinyl acetate dispensing, the batch was heated in the space of 50 minutes to 85° C. and held for 1 hour at this temperature. The batch was then cooled down. After this, a redox treatment (t-butyl-hydroperoxide/Brüggolit FF6) and/or a physical treatment was also carried out to reduce the residual monomers.

Characteristic Data of Sample Dispersion 1

Dry substance: 53.5%
pH (electrode measurement) 4.7
Viscosity per Brookfield (23° C., spindle 3, 20 rpm): 2200 mPas
Residual monomer content: <0.1%
Glass transition temperature of polymerizate (10 K/min): 27 ° C.
Particle size distribution (LAS): d,ᵥ =218 nm
d_{w}/dₙ=1.39

### Example 2

### Preparation of a Polymer Dispersion According to the Invention—2.5 wt. % Ethylene

Working similar to example 1, except that only 2.5 wt. % of ethylene was used in terms of the principal monomer (=ethylene+vinyl acetate). The proportion of vinyl acetate was increased accordingly.

Characteristic Data of Sample Dispersion 2

Dry substance: 53,2%

pH (electrode measurement): 4.6
Viscosity per Brookfield (23° C., spindle 3, 20 rpm): 1700 mPas
Residual monomer content: <0.1%
Glass transition temperature of polymerizate (10 K/min): 30 ° C.
Particle size distribution (LAS): d,ᵥ =186 nm
d_{w}/dₙ=1.35

### Example 3

### Preparation of a Polymer Dispersion According to the Invention—2.5 wt. % Ethylene, No Protective Colloid

Working similar to example 1, except that only 2.5 wt. % of ethylene was used in terms of the principal monomer (=ethylene+vinyl acetate) and no polyvinylalcohol was used. The proportion of vinyl acetate was increased accordingly.

Characteristic Data of Sample Dispersion 3

Dry substance: 54%
pH (electrode measurement): 4.6
Viscosity per Brookfield (23° C., spindle 3, 20 rpm): 1400 mPas
Residual monomer content: <0.1%
Glass transition temperature of polymerizate (10 K/min): 28° C.
Particle size distribution (LAS): d_{w}=166 nm
d_{w}/dₙ=1.25

### Example 4

### According to the Invention

In a pressure apparatus as in example 1 the following dispersion was prepared. A method with short polymerization time was used.

In the receiver:

9661 g of deionized water
543 g Celvol® 504 (15% in deionized water, polyvinylalcohol from Celanese)
543 g Emulsogen® EPN 287 (70% in deionized water, nonionic emulsifier based on an ethoxylate from Clariant)
423 g Texapon K12/15®(15% in deionized water, ionic sulfate-containing emulsifier from Cognis)
217 g sodium ethene sulfonate (30% in deionized water)
32.5 g sodium acetate
5.1 g sodium disulfite
0.03 g Mohr's salt

Monomer
12292 g vinyl acetate

Ethylene quantity
512 g ethylene

The polyvinylalcohol was previously dissolved in a 15% solution at 90° C. for 2 hours.

The apparatus was cleared of oxygen in the air. 20% of the monomer mixture (total quantity: 12292 g) was added to the reactor in the space of 10 min. The ethylene valve was opened at room temperature and ethylene was forced to a pressure of around 10 bar. The reactor was heated to an internal temperature of 65° C. When 35° C. was reached, initiator 1 (28.6 g of sodium peroxodisulfate in 227 g of deionized water) was added in the space of around 8 min. After reaching 65° C., the ethylene valve was opened (max. 15 bar) and the remaining 80% of the monomer mixture was dispensed in the space of 45 min, so that an internal temperature of around 110° C. could be maintained. Accordingly, the cooling has to be activated (in this case, at 95° C.). Once the internal temperature began to drop, the dispensing of initiator 2 (16.1 g sodium-peroxodisulfate in 227 g deionized water) was begun (around 7 min after the start of the monomer dispensing). After the monomer dispensing was complete, the dispensing of initiator 2 continued for yet another 30 min or so. After this, heating was continued for another hour at 85° C., in order to lower the content of residual monomer.

Characteristic Data of Sample Dispersion 4

Dry substance: 54.1%
pH (electrode measurement): 4.3
Viscosity per Brookfield (23° C., spindle 4, 20 rpm): 1920 mPas
Residual monomer content: <0.1%
Glass transition temperature of polymerizate (10 K/min): 28 ° C.
Particle size distribution (LAS): d,ᵥ =180 nm
d_{w}/dₙ=1.19

### Example 5

### Comparison Example: VAE Dispersion With a Larger Quantity of Ethylene (Not According to the Invention)

Working similar to example 1, except that 12 wt. % of ethylene was used in terms of the principal monomer (=ethylene+vinyl acetate). The quantity of vinyl acetate was increased accordingly.

Characteristic Data of Sample Dispersion 5

Dry substance: 54.5%
pH (electrode measurement): 4.6
Viscosity per Brookfield (23° C., spindle 3, 20 rpm): 3000 mPas
Residual monomer content: <0.1%
Glass transition temperature of polymerizate (10 K/min): 14 ° C.
Particle size distribution (LAS): d,ᵥ =215 nm
d_{w}/dₙ=1.5

### Example 6

### Comparison. SBR latex Litex T6820 from Polymer Latex

Litex® T 6820 is a commercial product from Polymer Latex

### Example 7

### Comparison. Vinyl Acetate Homopolymer, Without Softener. Mowilith PC

Mowilith® DC is a commercial product from Celanese Emulsions GmbH.

### Example 8

### Comparison, Medium-Hard SBR Latex with 59% Styrene

The comparison latex is a typical SBR latex for carpet backing coats with 59 wt. % styrene monomer units. The latex was made by emulsion polymerization, it is anionically stabilized, and it has a solid content of 50 wt. % and a particle size between 150 and 300 nm.

Application Tests

The results of the application tests of different dispersions on different substrates are presented in table 1.

TABLE 1
Application tests

| | Tensile | Tensile | Water | | | | | |
|---|---|---|---|---|---|---|---|---|
| | strength | strength, | drop | | | | | Pile nop |
| | dry | wet | test | Yellowing | Yellowing | | Breaking at | pull-out |
| | (N/5 cm) | (N/5 cm) | (min) | DIN 6167 | DIN 6167 | Stiffness | 180° | force (kg) |
| Substrate | Whatman | Whatman | Whatman | Whatman | Whatman | Woven | Woven | Woven |
| | Paper | Paper | Paper | Paper | Paper | carpet | carpet | carpet |
| | | | | | | (synthetic | (synthetic | (natural |
| | | | | | | fiber) | fiber) | fiber) |
| Dispersion | | | | 1 min; | 1 min; | | | |
| | | | | 180° C. | 200° C. | | | |
| Example 1 | 260 | 20 | 2 | 4.5 | 7.5 | 4 | No | |
| (per | | | | | | | | |
| invention) | | | | | | | | |
| Example 2 | 300 | 26 | 2 | 4.4 | 7.6 | 5 | No | 4.5 |
| (per | | | | | | | | |
| invention) | | | | | | | | |
| Example 3 | 280 | 24 | 1:30 | 4.4 | 7.5 | 5 | No | |
| (per | | | | | | | | |
| invention) | | | | | | | | |
| Example 4 | 280 | 22 | 2 | 4.5 | 7.4 | 4 | No | |
| (per | | | | | | | | |
| invention) | | | | | | | | |
| Example 5 | 220 | 15 | 2 | 4.5 | 7.3 | 1 | No | |
| (comparison) | | | | | | | | |
| Example 6 | 310 | 30 | 2.5 | 5.4 | 7.2 | 5 | No | |
| (comparison) | | | | | | | | |
| Example 7 | 340 | 30 | 20 | 4.9 | 7.3 | 6 | Yes | |
| (comparison) | | | | | | | | |
| Example 8 | | | | | | | | 2.5 |
| (comparison) | | | | | | | | |

The results presented in table 1 for the tensile strength, the water drop test and the yellowing test prove that the binders used according to the invention confer on the textile web materials similar properties to rigid SBR latexes traditionally used for carpet backing coats. The results furthermore show that the feel of the carpets coated according to the invention is comparable to the standard products. Furthermore, the so-called pile nop pull-out force represents a measure of the binding strength of a dispersion in the case of textile floor coverings. The example according to the invention (No. 2, table 1) shows a distinctly higher and thus improved pile nop pull-out force than the comparison example (No. 8, table 1).

The ethylene content of the VAE-copolymers used in the dispersions of the invention brings about an internal softener effect. This corresponds roughly to the behavior of a SBR latex. As compared to SBR latex, the VAE copolymer dispersion used according to the invention has a number of advantages. There is an improved flame resistance, and so formulations can be used with less content of flame retardants. Also, less smoke is produced upon burning of a textile product with backing coat according to the invention. Furthermore, the VAE copolymer dispersion is neutral in odor, it can be formulated with a low content of volatile organic components (“VOC”) or even without VOC, and it confers an exceptionally good aging resistance on the back-coated textile products.

Vinyl acetate homopolymer dispersions generally require softeners. These can migrate during use. The textile products according to the invention make do without softeners.

Another benefit as compared to softer VAE copolymer dispersions with glass transition temperatures below 15° C. or with VA homopolymer dispersions is the combination of increased stiffness with improved breaking behavior, as well as good dimensional stability.

Another benefit is the simple emulsion formula; the dispersion can be made by methods with short process duration (e.g., process duration of 3 to 5 hours, calculating from one empty reactor condition to another).

We claim:

1. Vinyl acetate-ethylene copolymer dispersion, derived from 60 to 99 wt. % vinyl acetate, 1 to 4 wt. % ethylene, wherein the copolymer has a glass transition temperature of +15 to +32° C., a mean particle size d_{w} of 50 to 500 nm, and is stabilized with at least 1 wt. % of emulsifiers and 0-2 wt. % of protective colloids, while in the case of stabilizer systems of emulsifiers and protective colloids the quantity of emulsifier is at least twice that of the quantity of protective colloid.

2. Vinyl acetate-ethylene copolymer dispersion according to claim 1, characterized in that the vinyl ester-ethylene copolymer is derived from up to 30 wt. % of other monomers that can polymerize with vinyl acetate and ethylene.

3. Vinyl acetate-ethylene copolymer dispersion according to one of claims 1 to 2, characterized in that its viscosity is 400 to 4000 mPas, measured at 25° C. with the Brookfield viscosimeter.

4. Vinyl acetate-ethylene copolymer dispersion according to one of claims 1 to 3, characterized in that the vinyl acetate-ethylene copolymer has an ethylene content of 1 to 3 wt. %.

5. Vinyl acetate-ethylene copolymer dispersion according to one of claims 1 to 4, characterized in that the glass transition temperature of the vinyl acetate-ethylene copolymers is between +20 and +30° C.

6. Vinyl acetate-ethylene copolymer dispersion according to one of claims 1 to 5, characterized in that this was obtained by polymerization in absence of a protective colloid.

7. Vinyl acetate-ethylene copolymer dispersion according to claim 2, characterized in that the other monomers than can copolymerize with vinyl acetate and ethylene are chosen from the group of ethylene-unsaturated acids, or their salts, ethylene-unsaturated monomers having at least one amide, epoxy, hydroxy, N-methylol, trialkoxysilane or carbonyl group, or combinations of two or more monomers from this group.

8. Vinyl acetate-ethylene copolymer dispersion according to claim 2, characterized in that the other monomers than can copolymerize with vinyl acetate and ethylene are chosen from the group of vinyl esters that are not vinyl acetate, the alpha-olefins that are not ethylene, the vinyl aromatics, the esters of ethylene-unsaturated monocarboxylic acids or the diesters of ethylene-unsaturated dicarboxylic acids.

9. Vinyl acetate-ethylene copolymer dispersion according to one of claims 1 to 8, characterized in that the emulsifiers contain no alkylphenylethoxylates.

10. Textile web material treated with a vinyl acetate-ethylene copolymer dispersion according to one of claims 1 to 9.

11. Textile web material according to claim 10, characterized in that is present in the form of a woven carpet or a tufted carpet that is coated and partly impregnated on the side away from the walking surface with the vinyl acetate-ethylene copolymer dispersion.

12. Textile web material according to claim 11, characterized in that the textile web material has a weight per unit of area of 1000 to 3000 g/m².

13. Textile web material according to claim 10, characterized in that this is present in the form of a carpet, which is glued to a secondary backing coating on the side away from the walking surface, wherein the gluing between the two layers is done with the vinyl ester-ethylene copolymerizate dispersion.

14. Textile web material according to claim 10, characterized in that this is present in the form of a carpet, where a textile web based on a heavy nonwoven is impregnated with the vinyl ester-ethylene copolymerizate dispersion.

15. Textile web material according to claim 14, characterized in that the nonwoven has a weight per unit of area of 200 to 600 g/m².

16. Textile web material according to claim 10, characterized in that this is present in the form of a belt, where a textile web is impregnated with the vinyl acetate-ethylene copolymer dispersion.

17. Textile web material according to claim 16, characterized in that the textile web material has a weight per unit of area of 500 to 3000 g/m².

18. Textile web material according to one of claims 10 to 17, characterized in that this has at least one textile web that is chosen from the group of nonwovens, wovens, scrims, knitted fabrics and pile materials.

19. Textile web material according to claim 18, characterized in that the pile material is coated and partly impregnated on the side away from the pile with the vinyl acetate-ethylene copolymer dispersion.

20. Use of a vinyl acetate-ethylene copolymer dispersion according to one of claims 1 to 9 for the impregnating and/or coating of textile web materials.

21. Use according to claim 20, characterized in that the textile web materials are used in the production of floor coverings or belts.
